(19) United States
(12) Patent Application Publication
(10) Pub. No.: US 2018/0319352 A1
(43) Pub. Date: Nov. 8, 2018

(54) FLOOR BOARD AND METHOD OF MANUFACTURING THE SAME

(71) Applicants: Hyundai Motor Company, Seoul (KR); Kia Motors Corporation, Seoul (KR)

(72) Inventors: Jin Young KWON, Gunpo-si (KR); In Chul BAIK, Jeonju-si (KR)

(73) Assignees: Hyundai Motor Company, Seoul (KR); Kia Motors Corporation, Seoul (KR)

(21) Appl. No.: 15/670,966

(22) Filed: Aug. 7, 2017

(30) Foreign Application Priority Data
May 8, 2017 (KR) 10-2017-0057349

(51) Int. Cl. B60R 13/01; B32B 21/08

(52) U.S. Cl. CPC B60R 13/01; B32B 21/08; B32B 2605/003; B32B 2255/26; B32B 2255/08

(57) ABSTRACT

A floor board and a method of manufacturing the same may include a body formed of wood and an external cover including a composition which is formed of wood flour and synthetic resin at a predetermined ratio, wherein the external cover surrounds at least part of an external surface of the body.

### CROSS-REFERENCE TO RELATED APPLICATION

The present application claims priority to Korean Patent Application No. 10-2017-0057349, filed on May 8, 2017, the entire contents of which is incorporated herein for all purposes by this reference.

### BACKGROUND OF THE INVENTION

### Field of the Invention

This present invention relates to a floor board and a method of manufacturing the same.

### Description of Related Art

A floor board is a member which is mounted on a floor of a specific object to protect the floor of the specific object.

The floor board is made of various materials, such as wood, marble, synthetic resin, etc., depending on a type of the specific object to which the floor board is applied.

For example, in the case that the specific object is one of other vehicles (hereinafter, referred to as “a truck”), the floor board is mounted on a floor of a truck cargo box. In the case that the floor board is mounted on the truck cargo box, conventionally, the floor board is made of wood in consideration of durability and weight.

However, the wood is generally vulnerable to moisture. Thus, if the wooden floor board is mounted on the floor of the truck cargo box, the floor board is corroded by external moisture. This may mean that the floor board is deformed.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a floor board which has an improved structure to prevent moisture from introducing into the floor board, and a method of manufacturing the floor board.

The technical problems to be solved by the present inventive concept are not limited to the aforementioned problems, and any other technical problems not mentioned herein will be clearly understood from the following description by those skilled in the art to which the present invention pertains.

According to various aspects of the present invention, a floor board including a body formed of wood and an external cover including a composition which is formed of wood flour and synthetic resin at a predetermined ratio, the external cover surrounding at least part of an external surface of the body.

The synthetic resin may include polypropylene.

The body may be formed of a carbonized log, in which lumber is manufactured by a high temperature thermal treatment.

The body may include at least one distortion groove, which is concavely formed on at least one surface of the body.

The body may include a coupling protrusion convexly formed on one surface of the body and a coupling groove concavely formed on an opposite surface to the one surface such that the coupling protrusion is inserted into the coupling groove.

The floor board may further include a fixing member mounted on a predetermined fixed part of the body to fix the body to a fixed object.

The floor board may further include a sealer filling the fixed part to seal the fixed part.

The fixed object may include a truck cargo box and the body may include an interference groove concavely formed such that a side gate of the truck cargo box is inserted into the interference groove.

According to another aspect of the present invention, a method of manufacturing a floor board, the method including (a) forming a composition, which is formed of wood flour and synthetic resin at a predetermined ratio and (b) coating an external surface of a body with the composition.

The method may further include (c) processing the body to have a predetermined shape before operation (b).

Operation (c) may include (c1) convexly forming a coupling protrusion on one surface of the body and concavely forming a coupling groove on an opposite surface to the one surface of the body such that the coupling protrusion is inserted into the coupling groove.

Operation (c) may include (c2) concavely forming at least one distortion groove on at least one surface of the body in a longitudinal direction of the body.

The body may be formed of a carbonized log, in which lumber is manufactured by a high temperature thermal treatment.

The synthetic resin may include polypropylene.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view illustrating a floor board according to an exemplary embodiment of the present invention;

FIG. 2 is a front view of the floor board illustrated in FIG. 1;

FIG. 3 is a view illustrating a flooring plate in which a plurality of floor boards illustrated in FIG. 1 are coupled to one another;

FIG. 4 is a view illustrating a form in which the floor plate illustrated in FIG. 3 is applied to a truck cargo box;

FIG. 5 is a flowchart illustrating a method of manufacturing a floor board, according to an exemplary embodiment of the present invention; and

FIG. 6 is a view illustrating a body formed by the method of manufacturing the floor board illustrated in FIG. 5.

It may be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, exemplary embodiments of the present invention will be described in detail with reference to the accompanying drawings. In the drawings, the same reference numerals will be assigned to the same elements even though the elements are shown in different drawings. In addition, a detailed description of well-known features or functions will be ruled out in order not to unnecessarily obscure the gist of the present invention.

In describing elements of exemplary embodiments of the present invention, the terms 1st, 2nd, first, second, ‘A’, ‘B’, (a), (b), and the like may be used herein. These terms are only used to distinguish one element from another element, and the nature, the order, or the sequence of the relevant elements is not limited to the terms. Unless otherwise defined, all terms used herein, including technical or scientific terms, have the same meanings as those generally understood by those skilled in the art to which the present invention pertains. Such terms as those defined in a generally used dictionary are configured to be interpreted as having meanings equal to the contextual meanings in the relevant field of art, and are not to be interpreted as having ideal or excessively formal meanings unless clearly defined as having such in the present application.

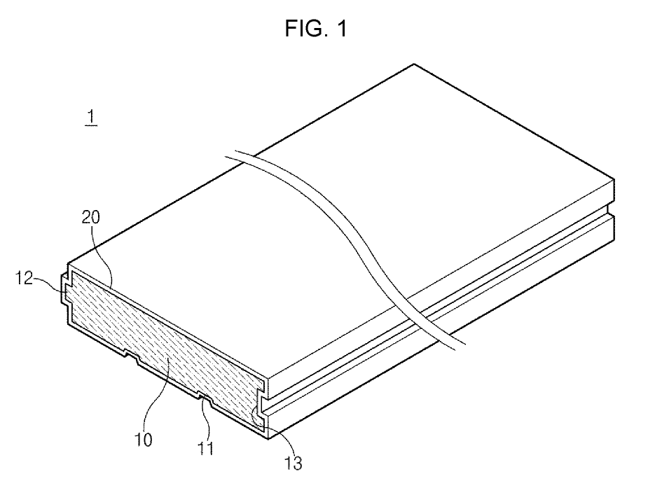

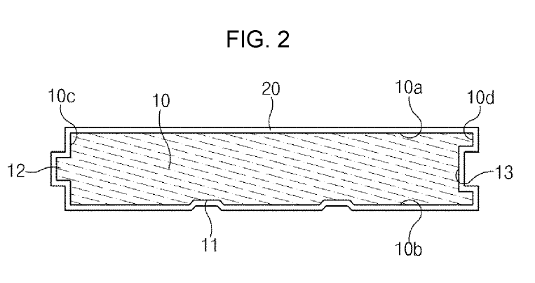

FIG. 1 is a view illustrating a floor board according to an exemplary embodiment of the present invention, and FIG. 2 is a front view of the floor board illustrated in FIG. 1.

As illustrated in FIG. 1 and FIG. 2, a floor board 1 of the present invention may include a body 10 made of wood and an external cover 20 surrounding an external surface of the body 10.

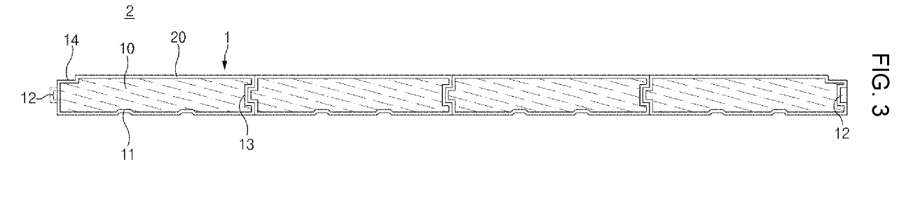

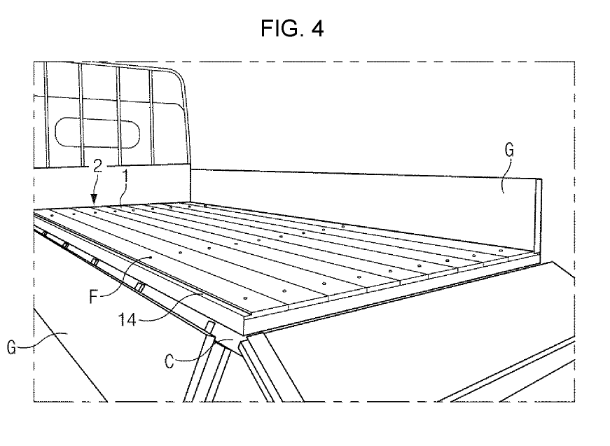

The floor board 1 is member corresponding to a minimum device of a floor plate 2 (see FIG. 3 and FIG. 4). The floor plate 2 is fixedly mounted on a floor of a fixed object ‘C’, which will be explained later, to protect the floor of the fixed object ‘C’. The present invention is not specially limited to a particular type of the fixed object ‘C’ to which the floor plate is applied. For example, the fixed object ‘C’ may be a cargo box of any other vehicles. Hereinafter, for the sake of convenient explanation, embodiments of the present invention will be explained under the condition that the fixed object ‘C’ is a truck cargo box.

The body 10 may include wood, which is processed by a moisture removal treatment. For example, the body 10 may include a carbonized log, which is manufactured by a high temperature thermal treatment to remove moisture from a pine material log.

The present invention is not specially limited to a shape of the body 10. For example, the body 10, as illustrated in FIG. 2, may have a rectangular shape including a pair of long sides parallel to each other and a pair of short sides, each of which connects one end portion of both end portions of one long side to one end portion of both end portions of the other long side and has a length less than that of the long side. For the sake of convenient explanation, among the long sides, a side positioned at an upper side of the body 10 is referred to as an upper surface 10a and a side positioned at a lower side of the body 10 is referred to as a lower surface 10b. In addition, among the short sides, a side positioned at one side of the body 10 is referred to as one side surface 10c and a side positioned at the other side of the body 10 is referred to as the other side surface 10d.

The body 10, as illustrated in FIG. 2 and FIG. 3, may include a coupling protrusion 12 convexly formed on the side surface 10c, a coupling groove 13 concavely formed on the other side surface 10d such that the coupling protrusion 12 is inserted into the coupling groove 13, a distortion prevention groove 11 concavely formed on the lower surface 10b, and an interference prevention groove 14 concavely formed on the upper surface 10a.

The coupling protrusion 12 and the coupling groove 13 are respectively formed on the side surfaces 10c and 10d of the body 10, to have shapes which correspond to each other. Floor boards 1 may be coupled with one another by a connection between the coupling protrusion 12 and the coupling groove 13. This connection of the floor boards 1 will be later explained in more detail.

The distortion prevention groove 11 is concavely formed on the lower surface 10b of the body 10 in a longitudinal direction of the body 10. The present invention is not limited to the number of the distortion prevention groove 11, but at least one distortion prevention groove 11 may be formed on the body 10. In general, shape deformation and distortion of wooden products often occur during a cooling process after manufacturing the wooden products. Since the body 10 has the distortion prevention groove 11, the distortion prevention groove 11 may prevent distortion of the body 10 in a cooling process of the body 10, which is heated during the other processes including a coating process of the external cover 20.

The body 10 which is provided on the truck cargo box, as illustrated in FIG. 4, has the interference prevention groove 14 which makes a portion of a side gate ‘G’ be inserted into the upper surface 10a of the body 10 to prevent interference between the side gate ‘G’ and the upper surface 10a of the body 10 when the side gate ‘G’ which opens or closes the truck cargo box rotates. In the instant case, as illustrated in FIG. 3, the interference prevention groove 14 is not formed in all bodies 10, but is formed in bodies 10, which are disposed at both end portions of the floor plate 2.

In sequence, the external cover 20 is formed of a composition, which is formed of wood flour and synthetic resin at a predetermined composite ratio. In addition to the wood flour and the synthetic resin, other additives may be added in the composition. The synthetic resin may be thermoplastic resin including polypropylene, although not limited thereto.

The external cover 20 is coated on the external surface of the body 10 to surround at least part of the external surface of the body 10, which includes the coupling protrusion 12, the coupling groove 13, the distortion prevention groove 11, and the interference prevention groove 14.

The external cover 20 may isolate the body 10 from the outside to prevent external moisture from introducing into the body 10.

FIG. 3 is a view illustrating a flooring plate in which a plurality of floor boards illustrated in FIG. 1 are coupled to one another, and FIG. 4 is a view illustrating a form in which the floor plate illustrated in FIG. 3 is applied to a truck cargo box.

Hereinafter, the coupling and mounting structure of the floor boards 1 will be explained with reference to the accompanying drawings.

The floor boards 1, as illustrated in FIG. 3, are coupled with one another by a grooved and tongued joint manner, in which a coupling groove 13 of one body 10 is inserted into a coupling protrusion 12 of another body 10, to form the floor plate 2. After the floor plate 2 is formed by the coupling of the floor boards 1 each other, a coupling protrusion 12, which is disposed on one end portion of the floor plate 2, of the floor board 1 is cut and the cut coupling protrusion 12 may be coupled to a coupling groove 13, which is disposed on the other end portion of the floor plate 2, of the floor board 1. In addition, a cut part where the coupling protrusion 12 is cut is filled with a sealer to prevent moisture from introducing into the body 10 through the cut part.

Meanwhile, the floor board 1, as illustrated in FIG. 4, may be further include a fixing member ‘F’ to fix the floor board 1 to the fixed object ‘C’.

The fixing member ‘F’ has a bolt or pin shape and is mounted on a predetermined fixing part of the body 10 to fix the floor board 1 to the fixed object ‘C’.

In the instant case, when the fixing member ‘F’ is mounted on the fixing part of the body 10, a gap is formed in the fixing part. The gap is filled with a sealer to seal the gap such that the sealer prevents moisture from introducing into the body 10 through the gap.

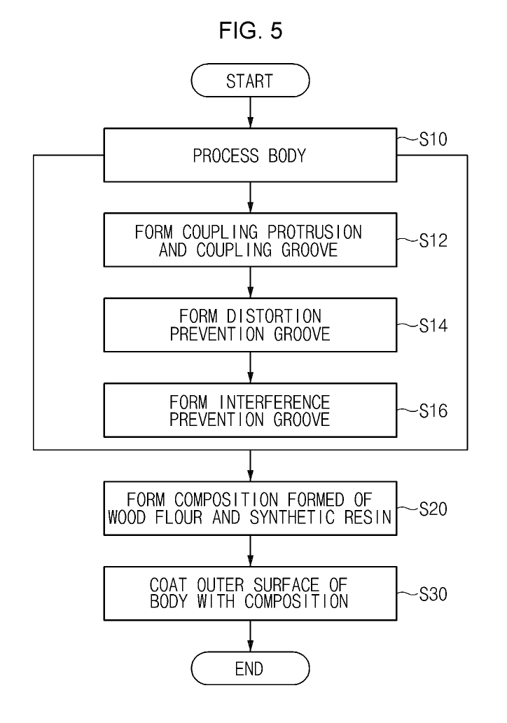

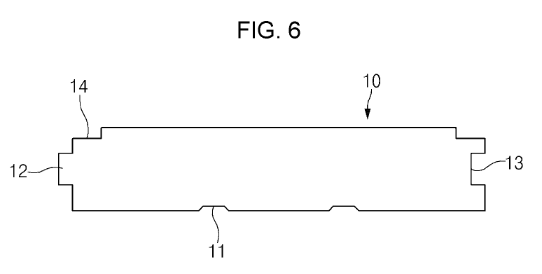

FIG. 5 is a flowchart illustrating a method of manufacturing a floor board, according to an exemplary embodiment of the present invention, and FIG. 6 is a view illustrating a body formed by the method of manufacturing the floor board illustrated in FIG. 5.

Referring to FIGS. 2 and 5, the method of manufacturing the floor board includes processing the wooden body 10 to have a predetermined shape (S10), forming a composition which is formed of wood flour and synthetic resin at a predetermined ratio (S20), and coating the external surface of the body 10 with the composition (S30).

First, operation S10 may include forming the coupling protrusion 12 and the coupling groove 13 on the body 10 (S12), forming the distortion prevention groove 11 (S14), and forming the interference prevention groove 14 (S16). The body 10 may be formed of a carbonized log, which is manufactured by a high temperature thermal treatment to remove moisture from lumber, although not limited thereto.

In operation S12, as illustrated in FIG. 6, the coupling protrusion 12 may be convexly formed on the side surface 10c of the body 10 and the coupling groove 13 may be concavely formed on the other side surface 10d of the body 10 such that the coupling protrusion 12 is inserted into the coupling groove 13.

In operation S14, at least one distortion groove 11 may be concavely formed on the lower surface 10b of the body 10 in a longitudinal direction of the body 10.

In Operation S16, at least one interference groove 14 is concavely forming on the upper surface 10a of the body 10 in a longitudinal direction of the body 10.

In sequence, operation S20 includes forming the composition, which is formed of the wood flour and the synthetic resin. The synthetic resin may be thermoplastic resin including polypropylene, although not limited thereto. In operation S20, the wood flour and the synthetic resin may be formed at the predetermined ratio, and the composite ratio may be variable depending on purpose of use. In addition to the wood flour and the synthetic resin, other additives may be added in the composition.

In succession, operation S30 may be performed by coating the external surface of the body 10 with the composition, which is formed in operation S20. Operation S30 may be performed by injecting the composition into a mold after inserting the body 10 into the mold, although not limited thereto. The composition coated on the external surface of the body 10 by operation S30 forms the external cover, which is capable to isolate the body 10 from external moisture.

Since a floor board and a method of manufacturing the same according to an exemplary embodiment of the present invention prevents moisture from introducing the floor board, quality of the floor board may be improved because corrosion or deformation of the floor board is prevented.

While the present invention has been described with reference to exemplary embodiments, it will be apparent to those skilled in the art that various changes and modifications may be made without departing from the spirit and scope of the present invention.

For convenience in explanation and accurate definition in the appended claims, the terms “upper”, “lower”, “internal”, “outer”, “up”, “down”, “upper”, “lower”, “upwards”, “downwards”, “front”, “rear”, “back”, “inside”, “outside”, “inwardly”, “outwardly”, “internal”, “external”, “internal”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

1. A floor board comprising:
a body formed of wood; and
an external cover including a composition which is formed of wood flour and synthetic resin at a predetermined ratio, the external cover surrounding at least a portion of an external surface of the body,
wherein the body includes two distortion prevention groove, which is concavely formed on a lower surface of the body in a longitudinal direction of the body.

2. The floor board of claim 1, wherein the synthetic resin includes polypropylene.

3. The floor board of claim 1, wherein the body is formed of a carbonized log, in which lumber is manufactured by a high temperature thermal treatment.

4. (canceled)

5. The floor board of claim 1, wherein the body includes:
a coupling protrusion convexly formed on one surface of the body; and
a coupling groove concavely formed on an opposite surface of the body to the one surface, wherein a coupling protrusion of an adjacent floor board is inserted into the coupling groove.

6. The floor board of claim 1, further including a fixing member mounted on a predetermined fixed portion of the body to fix the body to a fixed object.

7. The floor board of claim 6, further including a sealer filling the fixed portion to seal the fixed portion.

8. The floor board of claim 6, wherein the fixed object includes a truck cargo box; and
wherein the body includes an interference groove concavely formed, and wherein a side gate of the truck cargo box is inserted into the interference groove.

9. A method of manufacturing a floor board, the method comprising:
(a) forming a composition, which is formed of wood flour and synthetic resin at a predetermined ratio;
(b) coating an external surface of a body of the floor board with the composition; and
(c) processing the body to have a predetermined shape before the operation (b),
wherein the operation (c) includes:
concavely forming two distortion prevention groove on a lower surface of the body in a longitudinal direction of the body.

10. (canceled)

11. The method of claim 9, wherein the operation (c) further includes:
convexly forming a coupling protrusion on one surface of the body and concavely forming a coupling groove on an opposite surface of the body to the one surface of the body, wherein a coupling protrusion of an adjacent floor board is inserted into the coupling groove.

12. (canceled)

13. The method of claim 9, wherein the body is formed of a carbonized log, in which lumber is manufactured by a high temperature thermal treatment.

14. The method of claim 9, wherein the synthetic resin includes polypropylene.
